(19) United States
(12) Patent Application Publication
(10) Pub. No.: US 2013/0324916 A1
(43) Pub. Date: Dec. 5, 2013

(54) CORPOREAL CATHETERS

(71) Applicant: Radius International, Inc., Grayslake, IL (US)

(72) Inventor: David G. Quinn, Grayslake, IL (US)

(21) Appl. No.: 13/906,478

(22) Filed: May 31, 2013

Related U.S. Application Data
(60) Provisional application No. 61/654,448, filed on Jun. 1, 2012.

(51) Int. Cl. A61J 15/00

(52) U.S. Cl. CPC A61J 15/0096
USPC 604/30; 604/35

(57) ABSTRACT

The catheter invention is composed of three basic designs directly associated with gastric aspiration and jejunal feeding of polymeric diets. The first catheter embodies a triple lumen gastric sump that provides for gastric aspiration and air venting, along with deep jejunal feeding. The second design is dual lumen gastric tube that provides for gastric aspiration and deep jejunal feeding, but does not provide for gastric air venting. The third invention is a dual lumen design to replace existing Salem Sumps that provide gastric aspiration and air venting.

### RELATED APPLICATIONS

This application is based upon Provisional Application Ser. No. 61/654,448, filed on Jun. 1, 2012, and claims herein priority therefrom. Provisional Application Ser. No. 61/654,448 is incorporated herein by reference in its entirety.

### FIELD OF THE INVENTION

Medical equipment and methods.

### BACKGROUND OF THE INVENTION

The invention relates in general to corporeal catheters. It relates particularly to gastric aspiration and gastric or deep jejunal catheters. It also relates to catheters where enteral feeding is accomplished. In addition, the invention relates to corporeal catheters where aspiration and infusion are occurring simultaneously. In addition, it relates to corporeal catheters for wound drainage.

### SUMMARY OF THE INVENTION

This invention includes three separate catheter embodiments. The first invention embodiment is a catheter assembly that provides for simultaneous catheter functions, jejunal feeding, gastric aspiration with accompanying gastric air venting. The second embodiment, directly related, provides only two functions, jejunal feeding and gastric aspiration. The third embodiment also provides two functions, gastric aspiration and gastric air venting.

In the first triple function catheter invention: jejunal feeding, gastric aspiration and air venting; and the third described dual function invention: gastric aspiration and gastric venting, one of the hemodialysis concepts directly applies to gastric aspiration and air venting. In both of the above-described inventions, the gastric aspiration port can be compared to a hemodialysis arterial fluid receiving port and the air vent port can be compared to the hemodialysis infusing venous port.

The aspirating port and the air vent port are located at points where the most distal portion of the aspirating port is formed where its periphery meets the imaginary cylindrical portion of the catheter opposite the most proximal portion of the air vent port and beneath it. In other words, one port over-laps the other port. Unlike known gastric aspiration catheters, there is not a complete space between the ports. This positioning ensures that the fast and directed inflow from the aspirating port moves quickly away from the slower and more delicate vacuum created inflow from the air vent port before they can mix. In both inventions utilizing both an air venting port and a gastric aspiration port, the air venting port is located proximal to the gastric aspiration port.

Both ramps serving the air vent ports are identical. The main portion of the air vent ramps climb from the main longitudinal catheter axis at 21 degrees. This angle has been found to be ideal for directing flow upward and forward away from the catheter body. Both ramps serving the aspiration ramps of invention embodiments one, two and three are also identical, but slightly modified from the air vent ramps. They also all climb in a ramp that never exceeds 21 degrees. However, the initial portion of the ramps rise from the main longitudinal catheter axis in a 0.323 arc that meets the leading bolus tip forming ellipse at the imaginary 21 degree axis climb rate. This slight radius maintains the desired climb rate but adds to the overall effectives side cross-sectional area of the aspiration port. This is an important feature which provides maximal cross-sectional flow space of the port and prevents clogging by drawn in gastric mucosa.

Unlike other gastric aspiration catheters, the air lumen ports of the catheter embodiments one and three have their air inflow lumens proximal to their aspiration lumens. No mixing occurs because the air flows away naturally from the aspiration port and because of the directional flow of the ports.

### BRIEF DESCRIPTION OF THE DRAWINGS

There are three related catheter inventions described in this application. The first catheter invention is the foundation for the other two. It is covered by drawings FIG. 1 through 31.

FIG. 1 is a cross-sectional view of a catheter tube taken along line 1-1 of FIG. 14. It shows a triple lumen tube divided by a straight septum into a diameter extending lumen comprising approximately 50% of the total overall lumen and a radius based lumen that divides the remaining 50% of the lumen into two equal lumens that each comprise approximately 25% of the main tube lumen.

FIG. 2 is a side elevational view showing features of the catheter invention seen in FIG. 14 including the main gastric aspiration port and the jejunal feeding tube portion.

FIG. 3 is a side elevational view of the catheter as seen in FIG. 2, but from the opposite side, showing the air vent port, the gastric aspiration port and the jejunal feeding tube.

FIG. 4 is a top plan view of the catheter in FIG. 2 that illustrates the air vent port, and its ascending ramp and the feeding tube.

FIG. 5 is the opposite top plan view of FIG. 2 showing the aspirating port and the feeding tube.

FIG. 6 is a perspective of the skived tube seen in FIG. 1, showing the three lumens.

FIG. 7 is a perspective of the tip bolus over-molded on to the skived tubing shown in FIG. 6.

FIG. 8 is a perspective of the skived tube shown in FIG. 6, especially showing the single lumen skived portion of the feeding tube lumen.

FIG. 9 is a perspective of the tip bolus over-molded on to the skived tube shown in FIG. 8.

FIG. 10 is a cross-section taken along lines 10-10 of the catheter in FIG. 14 showing the over-molded bolus portion, the skived tube and the aspiration lumen.

FIG. 11 is a cross-section taken along lines 10-10 of FIG. 14 showing, in phantom, the ascending ramp of the air vent lumen.

FIG. 12 is a phantom cross-section showing the feeding tube lumen of the skived tube.

FIG. 13 shows the injection molding core pin of the feeding tube positioned by a dotted line with its relationship with FIG. 12;

FIG. 14 is a sectioned version of FIG. 2.

FIGS. 15 through 22 are all taken through corresponding sections of the catheter seen in FIG. 14.

FIG. 15 is a cross-section of FIG. 14 that shows the skiving of the air vent lumen seen most clearly in FIG. 8.

FIG. 16 is a cross-section showing the gradual filling during the over-molding process of the air vent port ascending ramp in the catheter of FIG. 14.

FIG. 17 shows the complete filling of the air vent ramp.

FIG. 18 shows the initial filling of the aspiration-ascending ramp.

FIG. 19 shows the continued filling of the aspiration-ascending ramp and the over-molding of the feeding tube lumen.

FIG. 20 shows the transition of the feeding tube lumen from the skived tube portion to the actual feeding tube lumen.

FIG. 21 shows the molded bolus socket inclosing the separate jejunal feeding tube component.

FIG. 22 is a cross-section of the feeding tube.

FIG. 23 combines the catheter invention of FIG. 2 with the entire feeding tube portion of the invention, including the single lumen feeding tube tip port at the end of a 32 inch 9FR. feeding tube section.

FIG. 24 shows the relationship of the extended over-molded portion of the bolus that overlays the feeding tube socket and the main over-molding.

FIG. 25 is the outline of the feeding tube lumen of FIG. 1.

FIG. 26 superimposes the phantom circular section that fits into the outline described in FIG. 25.

FIG. 27 superimposes the outline of the feeding tube lumen.

FIG. 28 superimposes the outline of the OD of the feeding tube on FIG. 27.

FIG. 29 is a superimposed collection of all the circular transition shapes from one tangential point.

FIG. 30 is a side elevational view of the injection molding core pin utilized to form the bolus tube flow lumen and the tube molded retention socket.

FIG. 31 is a top plan view of the molding core pin.

FIGS. 32 through 46 illustrate the second version of the catheter invention. The aspiration and feeding components of this invention are virtually identical to the previously described design, but the air vent lumen is eliminated because venting is not normally utilized in the U.K. and Europe.

FIG. 32 is a cross-section taken at 32-32 of FIG. 34. It is a dual lumen tube with one lumen approximately 2× the smaller lumen. The large lumen is the gastric aspiration lumen and the smaller lumen is the feeding lumen.

FIG. 33 is a cross-section taken at 33-33 of FIG. 34 of the feeding tube.

FIG. 34 is a side elevational view of the catheter invention, showing the bolus tip.

FIG. 35 is a cross-section taken at 35-35 of FIG. 34 showing the feeding lumen and tube, and the aspiration lumen and port.

FIG. 35A is a side elevational view of the feeding tube molding core pin and its relationship to the over-molded section.

FIG. 36 is a top plan view of the aspiration bolus port and the feeding tube.

FIG. 37 is a side elevational view of the part shown in FIG. 34 as it relates to the single lumen feeding tube tip port located at the distal end of the 32″ feeding tube.

FIG. 38 is a top plan view of the skived dual lumen tube.

FIG. 39 shows the over-molded bolus section forming a perspective view of the invention shown in FIG. 34.

FIG. 40 is a cross-section outline of the feeding tube lumen shown in perspective in FIG. 38.

FIG. 41 superimposes the outline of the largest circular cross-section that can fit into the feeding tube without distorting it.

FIG. 42 superimposes the ID of the feeding lumen on FIG. 41.

FIG. 43 superimposes the outline of the feeding tube OD on FIG. 42.

FIG. 44 shows an overlay of the various circular components of the feeding tube.

FIG. 45 is a side elevational view of the injection molding core pin that forms the feeding lumen.

FIG. 46 is a top plan view the core pin.

FIGS. 47 through 55 describe the third version of the invention where only gastric aspiration and air venting are accomplished. There is no feeding lumen. The aspiration lumen and air venting lumens are similar in design as those described in the first triple lumen invention.

FIG. 47 is a cross-section of the basic feeding tube taken at 47-47 of FIG. 48. It is a similar dual lumen design as seen in FIG. 32. The feeding lumen becomes the air vent lumen.

FIG. 48 shows a side elevational view of the invention showing in side view the large aspiration lumen and the smaller air vent lumen.

FIG. 49 is a cross-sectional view taken at line 49-49 of FIG. 48.

FIG. 50 is a top plan view showing the aspiration lumen.

FIG. 51 is a bottom plan view showing the air vent lumen.

FIG. 52 is a top plan perspective view of the skived tube.

FIG. 53 is a top plan perspective view showing the skived tube over-molded to form the bolus tip and aspiration port.

FIG. 54 is a bottom plan perspective view showing the air lumen.

FIG. 55 is a bottom plan perspective view showing the skived tube over-molded to form the bolus tip and the air vent port.

FIG. 56 is the patented woven stylet that will be utilized to insert all three of the tube inventions described in this application.

FIG. 57 is a top plan view of the competitive prior art gastric sump catheter showing its radiopaque stripe and its ten aspiration ports and its single distal air vent port.

FIG. 58 is a side plan view of the sump shown in FIG. 57 with ports and cross sections identified.

FIGS. 59, 60, 61 and 62 show lumen cross sections corresponding to those identified in FIG. 58.

FIG. 63 is a side plan view of the dual lumen gastric aspiration tube described by FIGS. 47 through 55 that will compete directly with the prior art catheter shown in FIGS. 57 through 62.

FIG. 64 is a side plan view of the eight aspiration port single lumen gastric aspiration tube that is utilized in the U.K. and Europe.

FIG. 65 is a side plan view of the single lumen tip described in this application as a feeding tip for the first two inventions. It can be used for either feeding or aspiration.

FIG. 66 is a cross section of the catheter of FIG. 65 taken at section 66.

### DESCRIPTION OF THE PREFERRED EMBODIMENT

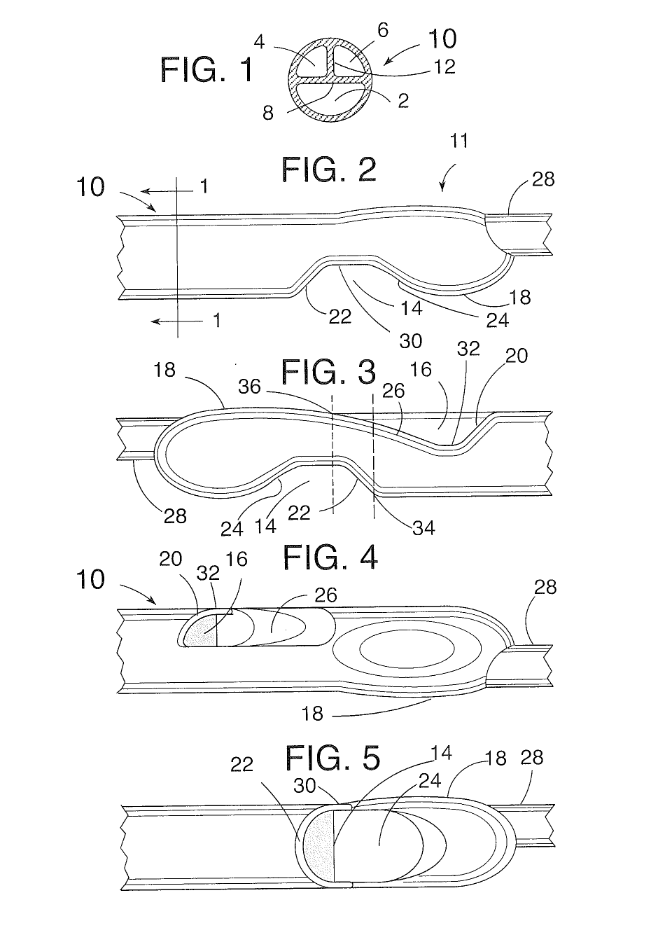

FIGS. 1 through 31 illustrate the main embodiment of the catheter disclosed in this patent application. This embodiment includes a triple lumen bolus tip that provides for jejunal feeding, gastric aspiration and gastric air venting during gastric aspiration.

Now referring to the drawings, and particularly FIGS. 1 through 5, FIG. 1 shows an extruded cylindrical triple lumen polyurethane tube seen at 10 as a cross-section of FIG. 2. Tube 10 has an outside diameter (OD) of 0.250″, or 18FR. The largest of the three tube lumens seen at 2 is a “D” shaped aspiration tube lumen that comprises approximately 50% of the tube's 10's internal bore and 180 degrees of its circumference. This main straight (normally incurred) dividing septum segment 8 straddles the internal diameter (ID) of the tube.

Still referring to FIG. 1, a straight divider septum segment 12 straddles the radius of tube 10 at 90 degrees to main straight ID septum segment 8, thereby dividing the remaining one-half of the internal bore of tube 10 into two equal internal tube lumens, tube feeding lumen 4 and tube air vent lumen 6. Both lumens 4 and 6 are identical in size and, in total, make up approximately the other one half of the tube 10 cross-section.

It is important to note that all tube interior divider segments, 4 and 8, are straight segments. It is important that they be straight for several reasons. First, if they are straight, they take up less room in the main tube 10 bore. Any curve of a divider septum segment means that it is longer and therefore takes up more space. The shortest distance between two points is a straight line. In addition, the internal inverted ‘T’ formed by the straight divider segments presents an internal support shape that resists kinking and also prevents the tube 10 bore from collapsing or deforming during the extrusion process.

Now referring to FIG. 2, which is a side elevational view from the side of the tube 10, that houses tube feeding lumen 4. Aspiration port 14 is formed by an over-molded bolus 18 that is formed by the 45 degree skive of tube 10 shown at 22 and the aspiration port ascending ramp show at 24. This ascending ramp 24 rises from the floor of the port at 21 degrees before it begins to taper. This ascending angle is meant to allow smooth and easy access for fluid inflow into the aspiration tube lumen 2.

Now again referring to FIGS. 1 through 5, air vent ascending ramp 26 rises from the floor of the tube air vent lumen at an angle of 21 degrees from the floor of the tube air vent lumen 4. This smooth 21 degree rise allows the incoming vented air to adhere to the surface and flow up the ascending ramp 26 to be directed without dispersing and mixing.

Extruded cylindrical feeding tube 28 is 0.124 in OD, or 9FR. This tube has an internal cross-sectional area of 0.0064 sq. inches that is identical to tube feeding lumen 4 and is an extension of the this lumen. In this 18FR. size this tube is approximately 32 inches long and extends deep into the jejunum where it is terminated with single lumen feeding tip bolus 38.

In FIGS. 4 and 5 the over-molded bolus 18 is seen to extend beyond the OD of the tube. This over-molding extension beyond the OD allows the over-molding 18 to enclose and trap the feeding tube 28 that is glued into a feeding tube retention socket 40 that is formed by the over-molding.

In FIG. 3, point 36 defines the most distal end of air vent flow port 16. Point 34 defines the beginning or most proximal point of aspiration flow port 14. The overlapping positioning of the two ports is key to the prevention of mixing between the two ports, one aspirating and one providing inflow, as described in co-pending International Patent Application No. PCT US 2012/026,478

Now referring to FIG. 3, the proximal end of air vent flow port 16 is proximal to the proximal end of aspiration flow port 14, or air vent flow port 16 is proximal to aspiration flow port. This position is important so that air is vented from the tube at a point that is proximal to aspiration so that ascending air is moving away from the aspiration of gastric material.

As will be explained later, in this application, current gastric aspiration devices vent the air distal to the aspiration ports, thereby creating a situation where ascending vent air is sucked into the aspiration line mixing it with aspirant and thereby impeding effective gastric aspiration.

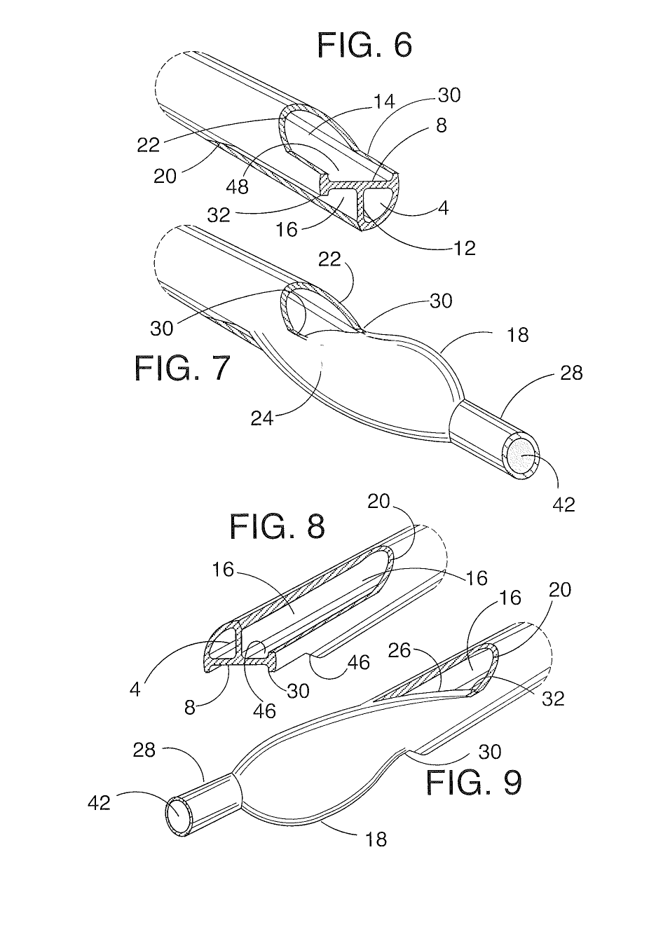

Now referring mainly to FIGS. 6 through 9. FIG. 6 shows in full the aspiration port 45 degree skived port opening 22 in the catheter illustrated there and a side partial view of the skived air vent skived 45 degree port opening at 20. The aspiration flow port floor is shown at 48.

FIG. 7 shows the skived extrusion of the catheter in FIG. 6 with the over-molded bolus 18 in place on said skived tube. The extrusion forms the aspiration tube side-walls or side rails 30 formed by the skiving and the skived air vent port wall or side rail.

FIG. 8 shows prominently the air vent 45 degree skived port opening 20 and the air vent flow port area at 16. The air vent flow port floor is seen at 46. FIG. 9 shows the skived tube of FIG. 8 over-molded to form the complete tip with the prominent illustration of the air vent flow port 16.

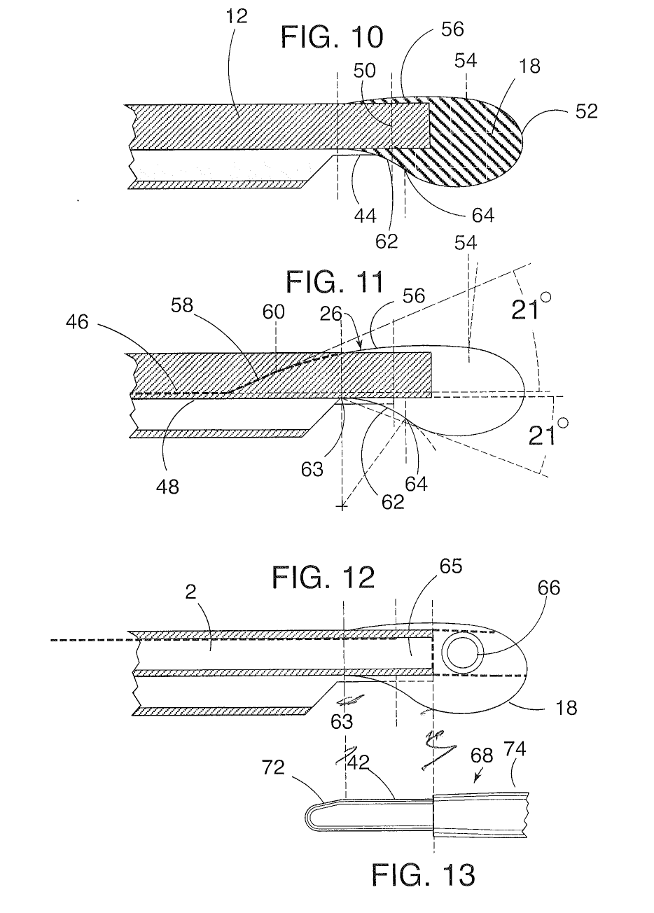

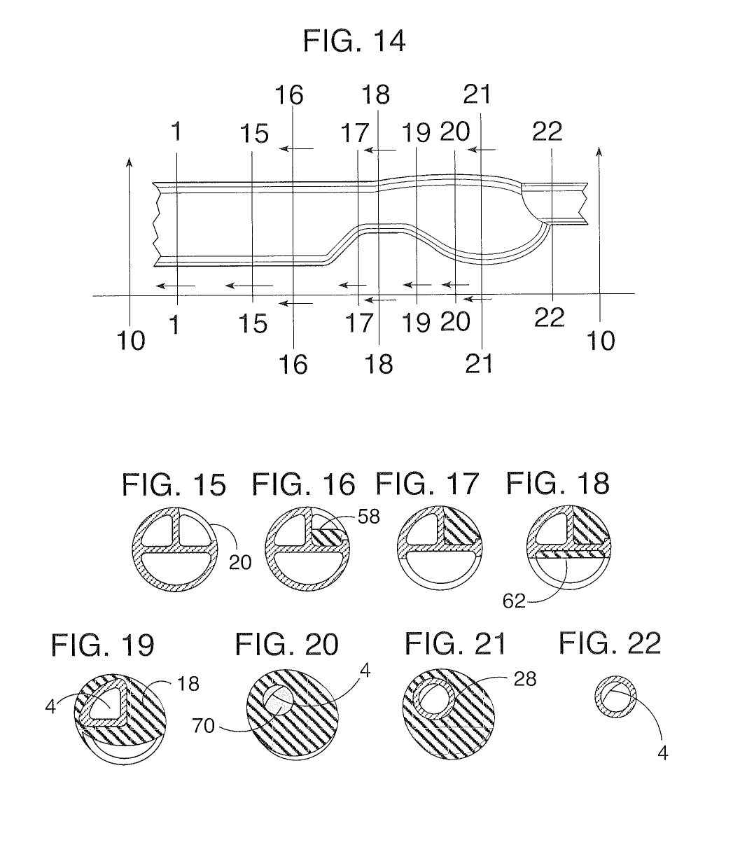

Now especially referring to FIGS. 10 through 14, they illustrate and describe the structure of the over-molded tip 18. FIG. 10 is a cross-sectional view taken through section 10 of FIG. 14. The section is taken through straight vent/feeding divider septum segment 12. FIG. 11 shows ascending air flow port ascending ramp 26 partially in dotted line “phantom” ascending from air vent flow port floor 46 point to point 54 where it meets over-molded ellipse 52.

The air vent flow port ascending ramp 26 is composed of two segments. The first segment is a straight segment ascending at an angle of 21 degrees from floor 46 and terminating at point 60 where it joins the second segment, radial arc 56, which is a radius of 1.278″. This ascending ramp design builds on the ramp designs of International Patent Application PCT US 2012/026478 that describes attracting and directing flow forward in a stream that minimizes mixing with adjacent aspiration ports.

Radial arc 56 connects tangentially with the over-molded ellipse 52 at point 54 and extends to form the “insertion friendly” tip until it meets tangentially the radial arc 62 that forms a segment of the aspiration ascending ramp 24 at point 64. The over-molded bolus is formed by an ellipse formed by dimensions X 0.257″ and Y 0.381″. The X dimension is slightly larger than the tube OD of 0.250″ because the bolus must be expanded slightly to made certain that the feeding tube 28 can be inserted into a receiving socket 66.

Radial arc 62 is 0.323″ and originates at the point 63 where the aspiration port 45 degree skive would extend to the floor 48 of the aspiration tube lumen 2. This point 63 assures that there is no obstruction for out flow from aspiration flow port 14.

As seen in FIG. 11, radial arc 62 tangentially meets ellipse 52 at point 64 so that there is no interference with flow. When aligned with floor point 63, the tangent point 64 provides a 21 degree effective ascending ramp incline. Radial arc 62 of 0.323 inches is used rather than a straight 21 degree segment because the arc provide additional cross-sectional area for aspiration port 14. Flow in this port is in, not out, and a larger port area trumps a true non-mixing, straight 21 degree ramp.

In FIG. 12, a cross-section of aspiration lumen 2 is shown. This lumen is over-molded to point 63, thereby trapping the skived tube of FIGS. 6 and 8. The feeding lumen is extended through the over-mold at 65. Section 66 is the formed feeding tube 28 retention socket that accepts the tube 28 for gluing.

FIG. 13 is a side elevational view of injection molding core pin 68 that provides for the transition from the shape of the tube feeding lumen 4 to the shape of the feeding tube 28. The core pin provides for transitions without undercuts that would impede the removal of the core pin during the molding process. FIGS. 24 through 31 provide a complete description of core pin 68.

Now referring to FIGS. 14 through 22. FIG. 14 shows the sections through the triple lumen, skived tube 10 and the over-molded bolus tip 18. FIG. 15 shows the beginning of the air vent port 20. FIG. 16 illustrates the filling of the straight ascending ramp segment 58. FIG. 17 shows the complete over-molding of the air vent ascending ramp 26. FIG. 18 illustrates the forming of the radial ascending ramp segment 62 at the point where it meets the level of the side rail 44. FIG. 19 show the continued filling of ascending aspiration ramp 24 and the over-molding of the skived feeding tube feeding lumen 4. FIG. 20 shows the formation 70 of the feeding lumen formed only by the core pin of FIG. 13, and also shows, at 4, the edge view of the original tube feeding shape before it is formed into its circular shape 42. FIG. 21 illustrates the complete forming of the bolus area to its OD of 0.257″ and the entrapment of feeding tube 28. FIG. 22 is a cross-section of the 9FR. feeding tube 28.

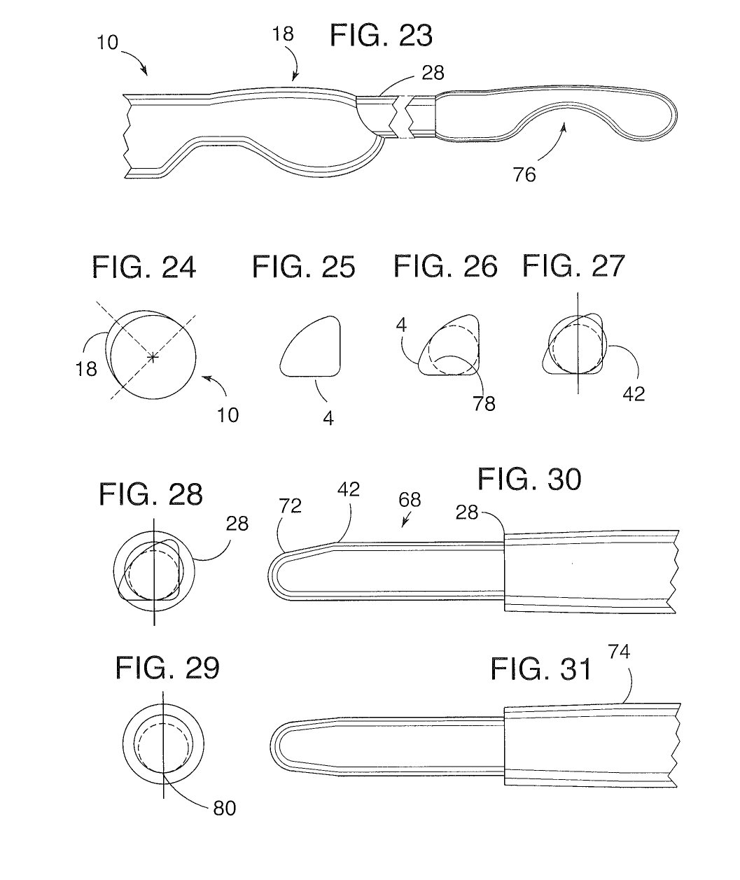

FIG. 23 illustrates the bolus assembly of triple lumen tube 10 and the bolus 18 into the final assembly for feeding, gastric aspirating and gastric venting. The feeding tube 28 of this assembly in this 18FR. version is approximately 32″ long where it connects at its distal end to feeding tip 78 described in the aforementioned PCT Application. The tip 78 placement is in the deep jejunum.

FIG. 24 shows in outline form the assembly of the extruded triple lumen tube 10 and the over-molded section 18 that encloses the feeding tube 28. FIG. 25 shows the outline of tube feeding lumen 4. FIG. 26 superimposes the outline 78 of the largest cylindrical core pin size OD possible without distorting the tube lumen 4. FIG. 27 superimposes the final cylindrical feeding tube lumen 42 on FIG. 26. FIG. 28 superimposes the OD of feeding tube 28 on FIG. 26. FIG. 29 shows the common tangent point 80 for all of the lumens transitioning from lumen 4, phantom lumen 78, cylindrical tube lumen 42 and final tube OD 28. This transitional point 29 is key to the development of an essentially straight lumen that will provide an unobstructive passage for a stylet that will stiffen the catheter assembly for easy insertion.

FIG. 30 is a side elevational view of the core pin 68 that allows for the formation of the previously described fluid path through the tip assembly. 72 is the oval tip that can be inserted into the tube lumen section 4 without distorting it. 42 marks the beginning of the formation of the cylindrical tube lumen. FIGS. 12 and 13 show this point graphically where the core pin prevents the collapsing of the lumen when the over-molding 18 takes place. FIG. 31 is a top elevational view of core pin 68 showing the central alignment of the core pin tip 72.

The invention described in these drawings is available in five French sizes 18FR., 16FR., 14FR., 12FR. and 10FR. The main aspirating lumen 2 cross-sectional area is 0.199 square inches, about 25% larger than the largest competitive prior art dual lumen Salem sump type device. The 16FR. version of the invention has an aspiration lumen 2 in the same size range as the 18 FR. competitive devices. In the case of the smaller FR. sizes of the invention, they all provide comparative aspiration lumens approximately two FR. sizes smaller than competitive devices.

In all FR. sizes of the invention, the venting lumen cross-sectional areas are of comparative size to the competition. All five sizes of the invention have feeding lumen 4 tube 28 sizes of standard feeding tubes: 18FR./9FR., 16FR./BFR., 14FR./7FR., 12FR./6FR. and 10FR./5F.R. The basic triple lumen, straight segment, design of the invention fits all five sizes perfectly for the purposes of aspiration, venting and feeding.

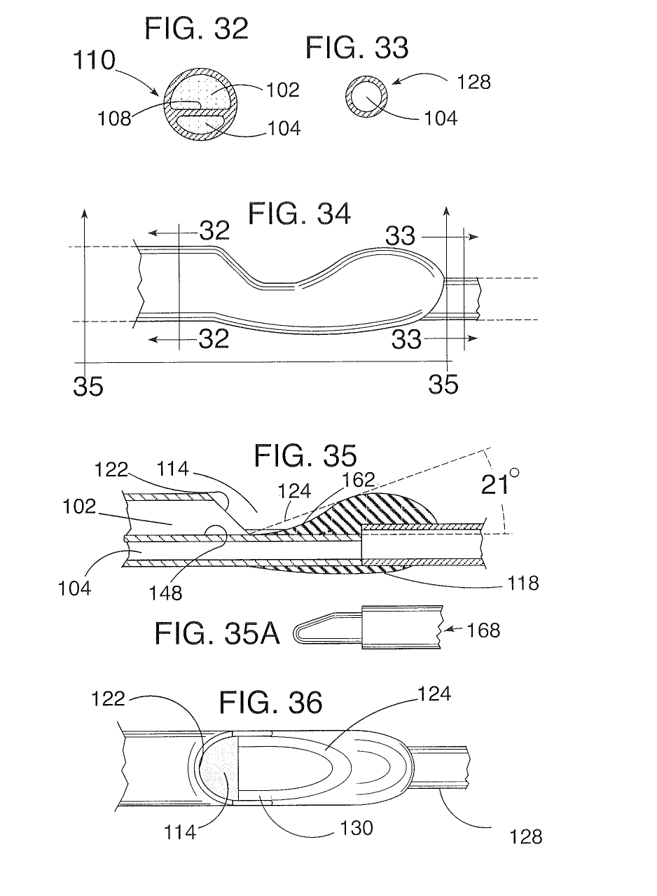

FIGS. 32 through 46 describe another directly related form of the triple lumen invention. In the United States gastric aspiration tubes, Salem Sumps, usually incorporate a separate gastric air venting lumen. This second air venting lumen is connected to central wall suction that provides the mechanism to suck out unwanted gastric contents. In the U.K. and mainland Europe, gastric suction is carried out by gravity siphoning, therefore there is no need for a second venting air lumen. Gastric drainage is accomplished by single lumen, multiport tubes.

Therefore, the foreign form of the previously described invention is to only feed and aspirate, but not vent, and requires only two lumens. However, this two lumen, foreign version still benefits from the aspiration and feeding features of the U.S. version. This dual lumen version also will be utilized in some cases in the U.S. for regular post-surgical use and also as a tube utilized with PEG tubes and percutaneous, endoscopic, gastrostomy tubes.

This second form of the invention employs the same basic component designs for aspiration and feed incorporated in the first design. The component numbering system for this device add a numeral “1” or “10” to the first invention numbers to convert them into three digit numerals. 1 becomes 101 and 10 becomes 110.

FIG. 32 shows the dual lumen tube at 110 with aspiration tube lumen 102, and feeding lumen 104 separated straight by segment septum 108. FIG. 33 shows the feeding tube assembly at 128 and the feeding tube flow lumen at 104. FIG. 34 shows these two cross-sections as well as longitudinal section 35 of FIG. 35. In previous FIG. 1 the “D” shaped aspiration lumen is formed by the diameter of the tube. In this case the “D” lumen incorporates over 50% of the tube lumen because the air vent lumen is removed. The drawings are of a 16FR. tube rather than an 18FR. tube. Just as is the case with the triple lumen, the aspiration port 114 is formed by the 45 degree skive 122 and the ascending 21 degree ramp 124. The ramp is also partially formed by radial arc 162 extending from the lumen floor 148.

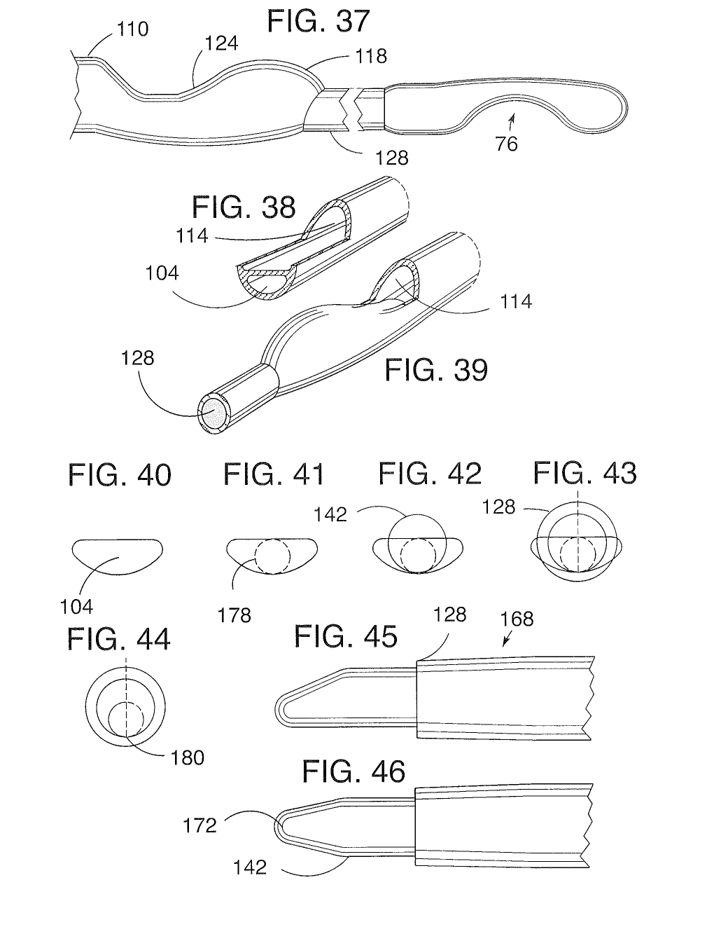

FIG. 35A shows the molding core pin 168 that provides the transition feeding tube lumen 104 to cylindrical feeding tube lumen 142. FIG. 34 is a side elevational view and FIG. 36 is a top plan view of the bolus. FIG. 37 shows the bolus end 118 connecting to the feeding tip 76 by tube 128.

FIGS. 40 through 44 show the transition of the feeding tube lumen from lumen 104 to cylindrical lumen 142. In FIG. 41 the height of the lumen 104 is shown by phantom circle 178. In FIG. 42 feeding tube lumen 14 is superimposed. And finally, in FIG. 43 the feeding tube 128 outline is added. In FIGS. 45 and 46 the tip end 172 of the core pin 168 is smaller to incorporate the lower height of the tub lumen 104.

FIG. 38 shows the skived tube for the part. FIG. 39 shows the skived tube over-molded.

ALL five sizes of the invention have feeding lumen 4 tube 28 sizes of standard feeding tubes: 28FR./19FR., 16FR./18FR., 14FR./7FR., 12FR./16FR. and 10FR./15FR. The basic triple lumen, straight segment, design of the invention fits all five sizes perfectly for the purposes of aspiration and feeding. French sizes are two to four sizes smaller than prior art competition can be used because the polyurethane catheter material allows smaller tube wall thicknesses.

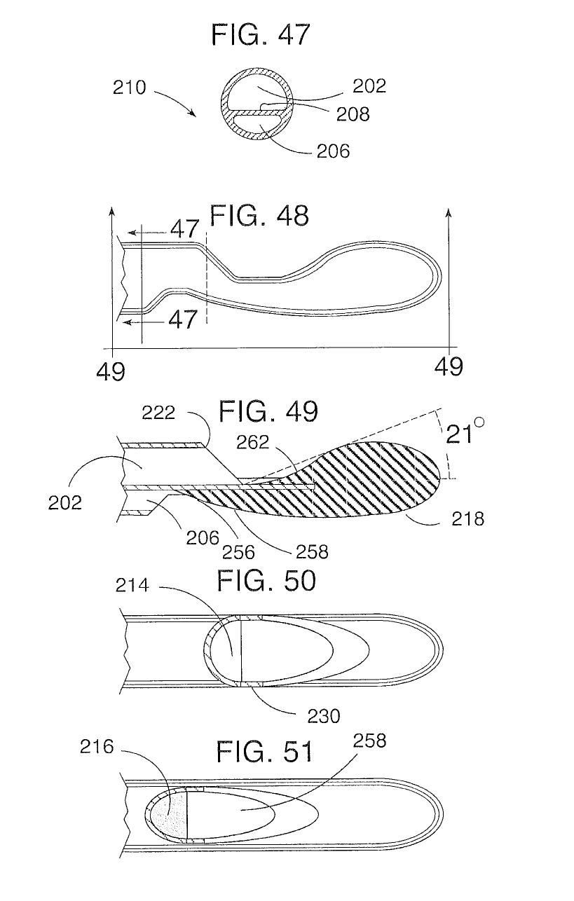

FIGS. 47 through 55 illustrate a dual lumen tube for gastric aspiration in the U.S.A. Here again, the port configurations mimic the ports described in the initial triple lumen tube for aspiration, gastric air venting and feeding. The first two inventions involved feeding. This invention only involves gastric aspiration in the U.S.A. where air venting is required. The numerical system adds a “2” to the designations of the first invention type.

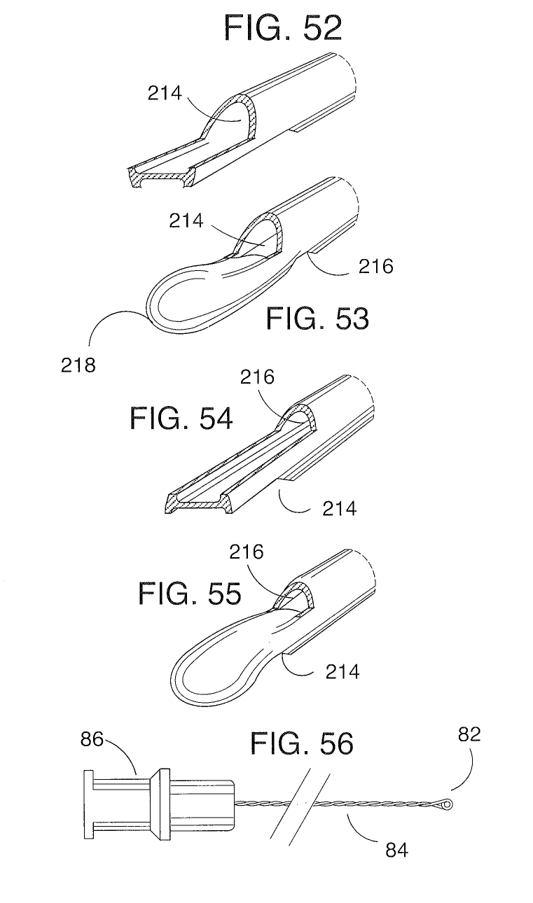

FIG. 47 is, coincidentally, the same port cross-section configuration as FIG. 32 and 16/FR. size as the previous cross-section shown in FIG. 32. However, in this application the lumen 104 feeding changes to 206 air venting. There is no change to ascending ramp 258 and straight initial section. FIGS. 52 and 53 show the skived tube and the over-molded tip with the aspirating lumen 214 on top. FIGS. 54 and 55 show the skived tubing and over-molded part with the air vent line 216 on the top. Note also in FIG. 49 point 222 defines the most proximal end of aspiration flow port 214 that overlaps air vent port 216. The overlapping positioning of the two ports is key to the prevention of mixing between the two ports, one aspirating and one providing air inflow, as best described in the co-pending (International) Patent Application PCT 2012/026,478.

ALL five sizes of the invention have tube the sizes of standard gastric aspiration tubes: 18FR./9FR., 16FR./8FR., 14FR./7FR., 12FR./6FR. and 10FR./5FR. purposes of aspiration. French (FR) sizes two to four sizes smaller than prior art competition can be used because the polyurethane catheter material allows smaller tube wall thicknesses.

This concludes the basic discussions of the three versions of the invention. This last invention is covered also by the aforementioned hemodialysis PCT Application. The following sections cover materials that are directly related to understanding the functions of the parts.

FIG. 56 is the woven wire stylet covered by U.S. Pat. No. 5,498,249. The largest versions of these designs will be as long as 82″ and will require stiffening stylets for easy insertion. This stylet will be utilized. It incorporates a formed tip 82, a woven wire 84 and a flow through connector 86.

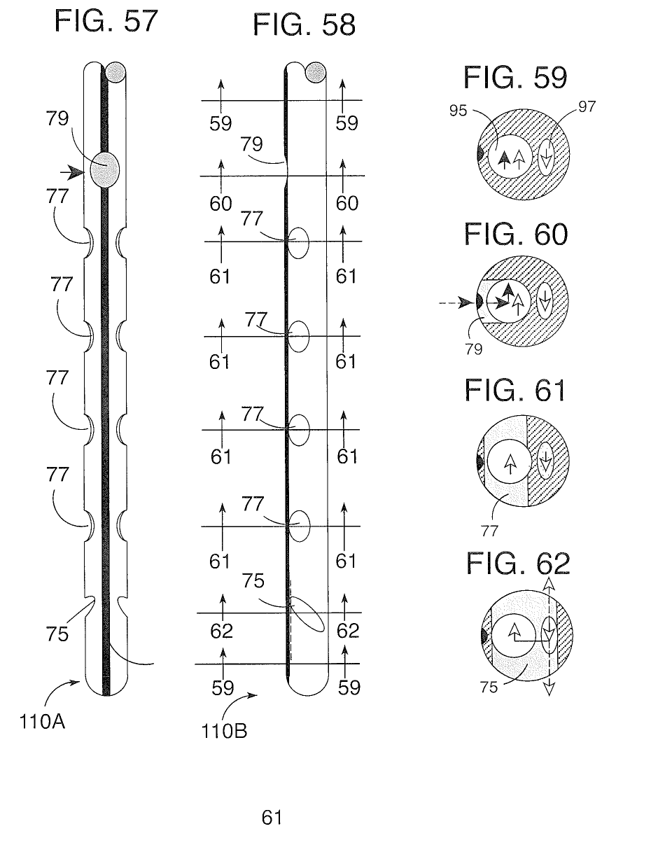

FIGS. 57 and 58 show the functional problems with the existing prior art in the United States standard gastric aspiration tube, known as a Salem Sump. FIG. 57 shows a top plan elevational view of the tube at 110A and FIG. 58 shows a side view at 110B. FIGS. 59, 60, 61 and 62 show expanded cross sections of FIG. 58. This tube is constructed of polyvinyl-chloride and has a large aspiration lumen 95 and a smaller air vent lumen 97 shown in FIG. 59. The walls are much thicker than urethane because PVC is a much weaker material. FR. sizes for all products are two to four FR. sizes smaller for urethane over PVC.

Also in FIG. 59, flow direction through both lumens is identified by arrows, black arrows for aspirant and white clear arrows for venting air. Note also in FIG. 59 that there are both a black arrow and a white arrow signifying that the aspirant lumen at the proximal end of the catheter contains a mixture of both aspirant and venting air.

FIG. 60 is a cross-section of the Salem sump at the point where the first single proximal aspiration port hole is located. As seen at port 79, the hole is punched through one side of the tube sidewall to form the port 79. The black aspirant arrows show aspirant flow into the tube port 79 and up the tube lumen proximally. The mixing of air and aspirant is also illustrated.

FIG. 61 shows the four cross sections of FIG. 58 illustrating identical cross sections and port configurations. The ports 77 are punched (cut) completely through the tube wall. These ports are designed to provide aspiration, but in actual usage almost all of the aspiration takes place at the proximal port 79 in FIG. 60. Note that the aspiration lumen only contains a white air arrow 97 whose flow direction is proximally where it will meet the aspirant being drawn in to port 79 in FIG. 60.

The port 75 shown in FIG. 62 is key. Port 75 is formed by punching (cutting) completely through the tube. However, unlike the punch of port 77 in FIG. 61 that severs only the aspirant lumen, the punch forming port 75 severs both the aspirant lumen and the air vent lumen.

Three separate, seven day observations of human usage of constant and intermittent Salem suction in a hospital situation have shown that almost all of the actual suction of aspirant is through the initial, most proximal port 79 shown in FIG. 60. The remaining, more distal, portion of the tube acts as a debris collection vessel. These hospital studies were supported by laboratory bench studies.

All of these hospital and bench studies showed that approximately 50% of incoming vent air flow through lumen 97 is diverted proximally back up aspirant lumen 95, thereby diluting the aspirant output by 50%. The other 50% of the incoming vent air properly enters the stomach through port 75.

There are several reasons why this unfortunate mixing of aspirant and vent air takes place. First, the air vent lumen port 75 is distal to the aspiration ports 77 and in most situations it is easier for the air to flow by gravity back up the aspiration lumen 95. Second, the air lumen 97 is in direct proximity to the aspiration lumen 95. Although little gastric aspirant is entering tube at any of the ports except the most proximal port 79, it is still easier for the light air to enter the aspiration port than the heavier, more viscous gastric aspirant. This air/aspirant mixing reduces the effective gastric fluid aspiration by approximately 50%. As previously stated, in these inventions the air vent port is always proximal to the gastric aspiration port.

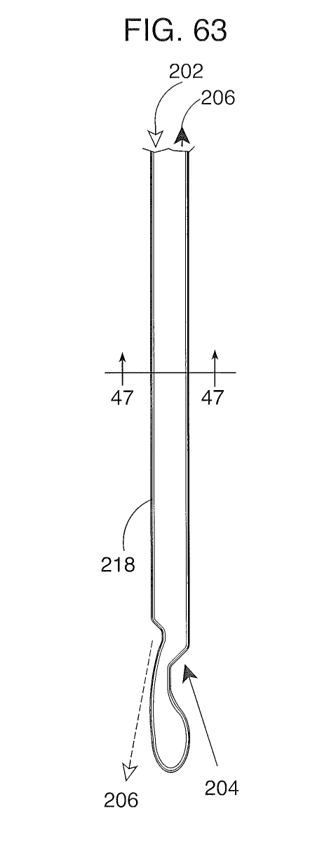

FIG. 63 shows the second invention catheter of this application previously described in FIGS. 47 through 55 that is designed to replace the Salem sump. This invention is described in FIGS. 47 through 55 of this application. Note the proximity and overlapping of air vent port 206 and aspiration port vent 204. Only one port is needed for aspiration and the vent port is distal to the aspirating port. The ascending overlapping ramps of the ports in combination with their overlapping design prevent mixing of vent air and aspirant. As previously stated, in these inventions the air vent port is always proximal to the gastric aspiration port.

FIG. 65 shows the side elevational view of the same feeding port 76 in use for gastric aspiration. The port design is shown in cross-section in FIG. 66 at section 66-66. This port design provides a larger effective port than any of the other designs covered in this application. Single lumen gastric aspiration is used in the U.K. and Europe where gastric air venting is not employed.

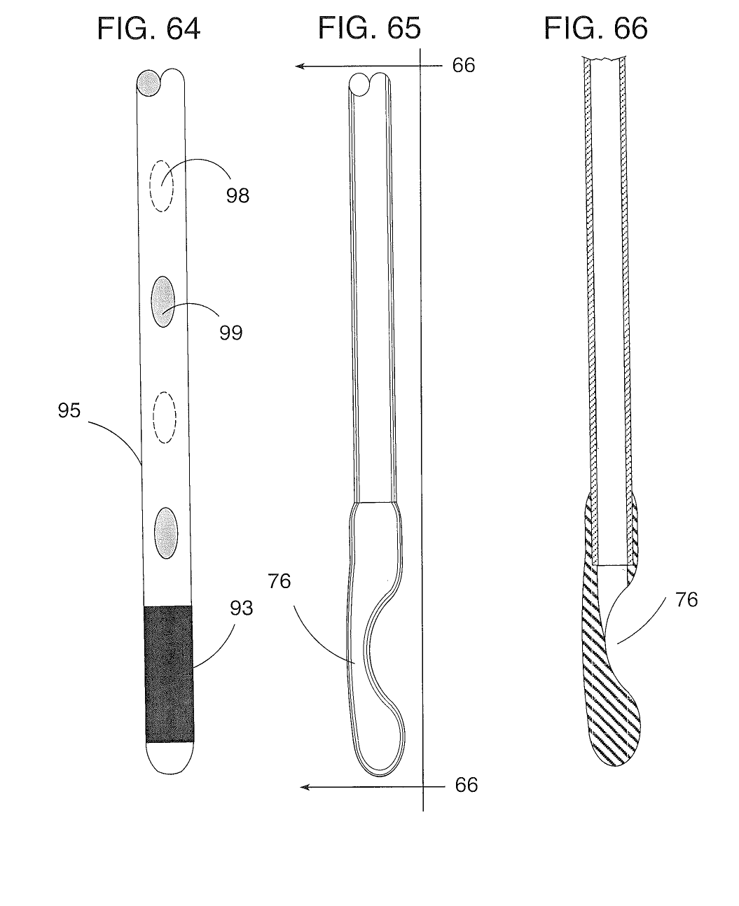

The single lumen, competitive Ryles tube is shown in FIG. 64. It has only eight flow ports. There are four ports on each side of tube in alternating positions. 95 identifies the front ports and 98 identifies the ports alternating on the other side of the tube. As is the case with the dual lumen Salem Sump tubes actual aspiration is achieved at the single most proximal port, 98.

1. An enteral catheter comprising:
a. a catheter tube containing a first lumen, a second lumen and a third lumen formed by two septums, said tube having a proximal and a distal end;
b. said septums being straight and not curved;
c. one septum extending from across the inside circumference of the tube to another point on the inside circumference of the tube to form a gastric aspiration lumen;
d. a second septum extending perpendicularly from the first septum to a point on the inside circumference of the tube to form an air vent lumen and a feeding lumen:
e. a bolus tip fastened to said tube on said distal end of said tube to form a tube and tip assembly;
f. a single lumen feeding tube extending from the feeding lumen formed in said bolus;
g. an air vent port extending radially out of said catheter assembly in communication with said air vent lumen;
h. an aspiration port extending radially out of said catheter assembly in a direction substantially opposite to the radial direction of said air vent port and in communication with said aspiration lumen;
i. said air vent port being located proximally to said aspiration port;
j. said air vent and aspiration ports each being longitudinally elongated with respect to the length of said tube and tip assembly with a position of said aspiration port being positioned closer to the said distal tip of the tip assembly than air vent port, and said air vent port overlapping said aspiration port along its length by at least a portion of the air vent port.
k. enteral aspiration is accomplished with only one port.

2. The enteral catheter of claim 1. is further characterized in that:
a. said air vent port includes a flow control ramp a which rises up from the septum in said air vent lumen at an angle of substantially 21 degrees.

3. The enteral catheter of claim 1 is further characterized in that:
a. said aspiration port includes a flow control ramp that has a radial surface that raises from the aspiration vent lumen that expands the cross sectional area of the said port;
b. said radial surface is formed at a perpendicular tangent point with the said floor of the aspiration port lumen;
said radial ramp surface meets tangentially with an ellipse that forms the leading distal end of the assembly;
c. the tangential meeting point between the radial ramp and the ellipse is at an angle of substantially 21 degrees.

4. The enteral catheter of claim 2. is further characterized in that:
a. said air vent ramp includes a flat surface that extends over 20% of the total distance from the corresponding system surface to the outside diameter of the tube.

5. The enteral catheters of claims 1. & 2. are further characterized in that:
a. each port is bracketed by side walls approximately 0.030″ high forming rails which direct flow and strengthen the assembly.

6. The enteral catheter of claim 1. is further characterized in that:
a. the air vent tube lumen and the aspiration tube lumen have D-shape through their entire lengths.

7. The enteral catheter of claim 1. is further characterized in that:
a. The feeding lumen transitions from a D-shape to a circular round shape;
b. said circular round shape forms a receiving socket to accept the single lumen feeding tube.

8. The enteral catheter of claim 1. is further characterized in that:
a. said catheter is extruded from thermoplastic polymer material; and
b. said bolus tip is over-molded with plastic on the distal end of said tube to form the air vent port and the aspiration port.

9. A dual lumen enteral catheter comprising:
a. A enteral feeding tube containing a first aspiration lumen and a second air vent lumen separated by a straight septum that extends across the ID of the tube, said tube having a proximal and a distal end;
b. a bolus tip fastened to said tube on said distal end of said tube to form a tube and tip assembly;
c. a first port extending radially out of said catheter assembly in communication with first said lumen;
d. a second port extending radially out of said catheter assembly in a direction substantially opposite to the radial direction of said first port and in communication with second lumen;
e. said first aspiration port and second air vent port each being longitudinally elongated with respect to the length of said tube and tip assembly with a position of said aspiration lumen being positioned closer to the tip than said second air vent port, and first port overlapping said second port along its length by at least a portion of the length of second port;
f. enteral aspiration is accomplished with one port.

10. The enteral catheter of claim 9. is further characterized in that:
a. said aspiration port includes a flow control ramp that has a radial surface that raises from the aspiration vent lumen that expands the cross sectional area of the said port;
b. said radial surface is formed at a perpendicular tangent point with the said floor of the aspiration port lumen;
c. said radial ramp surface meets tangentially with an ellipse that forms the leading distal end of the assembly;
d. the tangential meeting point between the radial ramp and the ellipse is at an angle of substantially 21 degrees.

11. The enteral catheter of claim 9. is further characterized in that:
a. said air vent port includes a flow control ramp a which rises up from the septum in said air vent lumen at an angle of substantially 21 degrees;

12. The enteral catheter of claim 9. is further characterized in that:
a. said air vent ramp includes a flat surface that extends over 20% of the total distance from the corresponding system surface to the outside diameter of the tube.

13. The enteral catheter of claim 9. is further characterized in that:
a. each port is bracketed by side walls approximately 0.030″ high forming rails that direct flow and strengthen the assembly.

14. A dual lumen enteral catheter comprising;
a. an enteral feeding tube containing a first aspiration lumen and a second feeding lumen separated by a straight septum that extends across the ID of the tube, said tube having a proximal and a distal end;
b. a bolus tip fastened to said tube to form a tube and tip assembly;
c. said aspiration port includes a flow control ramp that has a radial surface that raises from the aspiration vent lumen that expands the cross sectional area of the said port;
d. said radial surface is formed at a perpendicular tangent point with the said floor of the aspiration port lumen;
e. said radial ramp surface meets tangentially with an ellipse that forms the leading distal end of the assembly;
f. the tangential meeting point between the radial ramp and the ellipse is at an angle of substantially 21 degrees;
g. the aspiration port is bracketed by side walls approximately 0.030″ high forming rails that direct flow and strengthen the assembly;
h. both tube lumens are D-shaped;
i. enteral aspiration is accomplished with one port.

15. The enteral catheter of claim 14. is further characterized in that:
a. the feeding lumen transitions from a D-shape to a circular round shape;
b. said circular round shape forms a circular receiving socket to accept the single lumen feeding tube.
